(19) United States
(12) Patent Application Publication
(10) Pub. No.: US 2009/0024916 A1
(43) Pub. Date: Jan. 22, 2009

(54) Seamless Asynchronous Updates of Dynamic Content

(76) Inventors: Erik J. BURCKART, RALEIGH, NC (US); ANDREW IVORY, Wake Forest, NC (US); Aaron K. SHOOK, Morrisville, NC (US)

Correspondence Address: DILLON & YUDELL LLP, 8911 N. CAPITAL OF TEXAS HWY., SUITE 2110, AUSTIN, TX, 78759, US

(21) Appl. No.: 11/780,865

(22) Filed: Jul. 20, 2007

(51) Int. Cl. G06F 15/173; G06F 17/00

(52) U.S. Cl. 715/241; 709/203

(57) ABSTRACT

A master web page is partitioned into multiple partitions to create a partitioned web page. Each of the multiple partitions is correlated with a corresponding partition cache in a browser. The browser polls a web server for any invalidation event, wherein the invalidation event changes a content of an invalid partition from the multiple defined partitions. In response to the polling detecting the invalidation event, an identifier of the invalid partition is sent to the browser. Utilizing the identifier, a request is sent for new content that will update the invalid partition. This new content is sent to the browser, which updates the invalid partition with the new content, thus updating the partitioned web page without affecting the other partitions of the partition web page.

### BACKGROUND OF THE INVENTION

The present disclosure relates to the field of computers, and specifically to software. Still more specifically, the present disclosure relates to management of dynamic content in a Graphical User Interface (GUI).

Graphical User Interfaces (GUIs) are used by a video display to present content to a user. An exemplary content is a web page, which is presented through the use of a browser on the client side, which utilizes content from a web server to instantiate the web page. When a user desires a new web page, the user sends a signal to the browser to instantiate that new web page.

### BRIEF SUMMARY OF THE INVENTION

A master web page is partitioned into multiple partitions to create a partitioned web page. Each of the multiple partitions is correlated with a corresponding partition cache in a browser. The browser polls a web server for any invalidation event, such that the invalidation event changes a content of an invalid partition from the multiple partitions. In response to the polling detecting the invalidation event, an identifier of the invalid partition is sent to the browser. Utilizing the identifier, a request is sent for new content that will update the invalid partition. This new content is sent to the browser, which updates the invalid partition with the new content, thus updating the partitioned web page without affecting the other partitions of the partition web page.

The above as well as additional objectives, features, and advantages of the present invention will become apparent in the following detailed written description.

### BRIEF DESCRIPTION OF THE SEVERAL VIEWS OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts an exemplary computer in which the present invention may be implemented;

FIG. 2 illustrates a relationship between a client browser, a web server, and a content server; and

FIG. 3 is a flow-chart of exemplary steps taken to asynchronously update dynamic content in a GUI.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

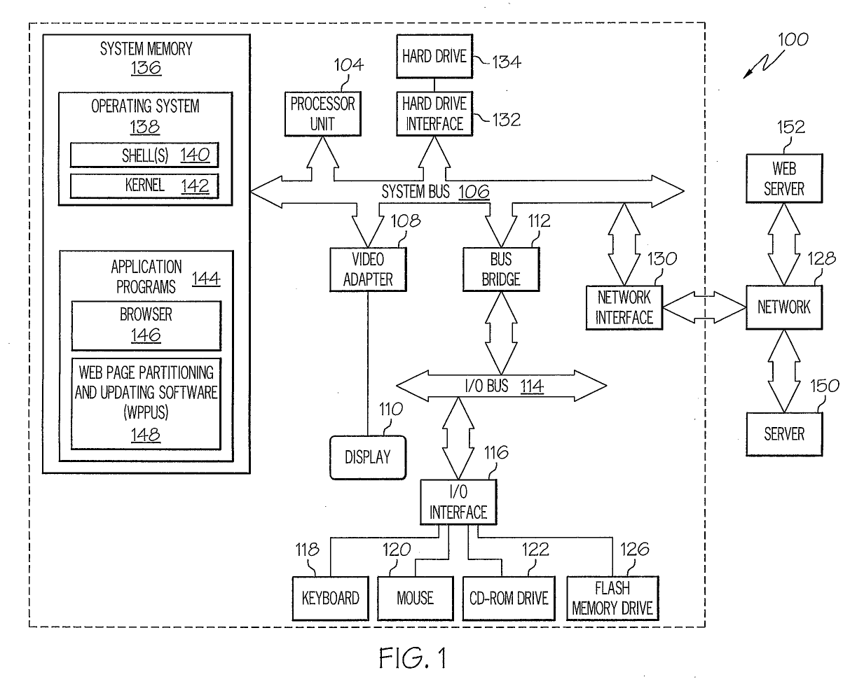

With reference now to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a server 150 and a Web Server 152 via a network 128 using a network interface 130, which is coupled to system bus 106. Network 128 may be an external network such as the Internet, or an internal network such as an Ethernet or a Virtual Private Network (VPN). Server 150 and Web Server 152 may be architecturally configured in the manner that is substantially similar to that depicted for computer 100. As described below, server 150 is able to provide software in an “on demand” manner to computer 100, while web server 152 provides web pages to computer 100 via a browser 146 (described below).

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

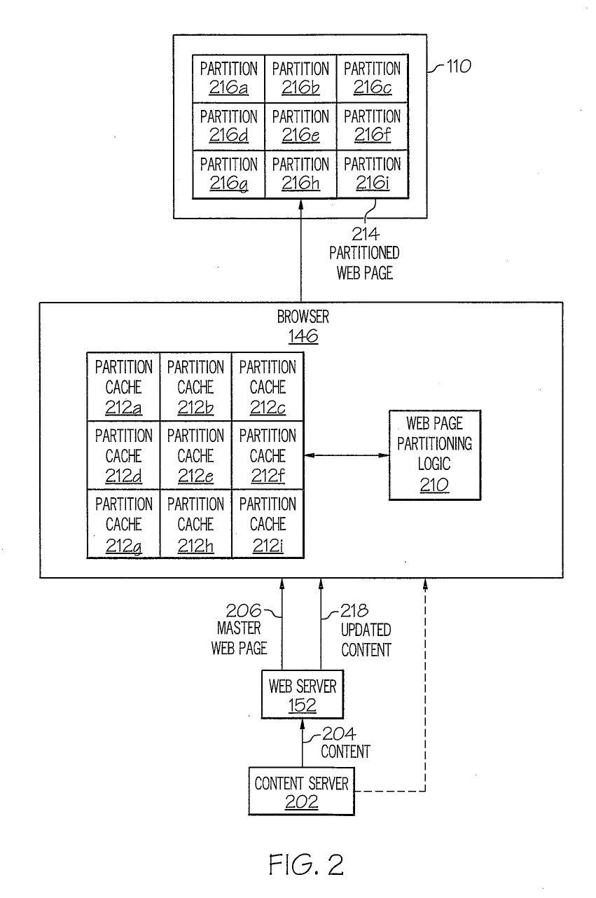

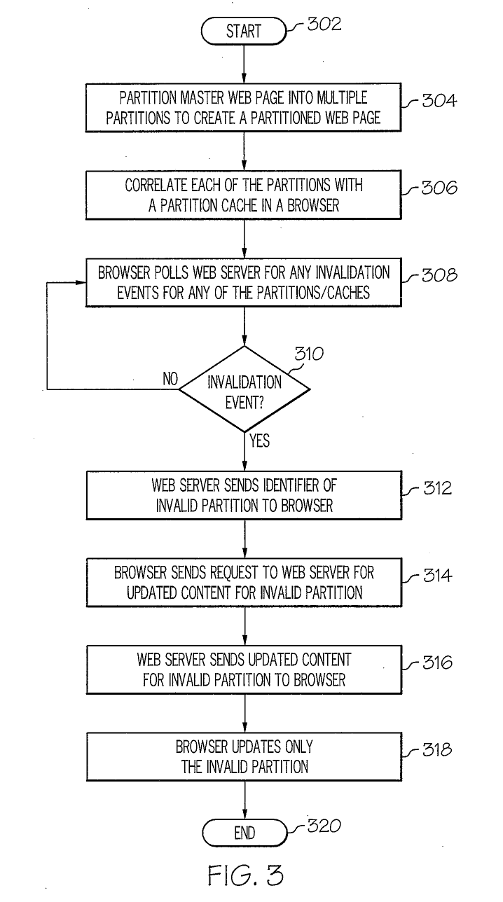

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150 and Web Server 152. Application programs 144 in system memory 136 also include a Web Page Partitioning and Updating Software (WPPUS) 148. WPPUS 148 performs the functions illustrated below in FIGS. 2-3. In one embodiment, computer 100 is able to download WPPUS 148 from a service provider that is utilizing server 150, preferably in an “on demand” basis. Note further that, in one embodiment of the present invention, server 150 performs all of the functions associated with the present invention (including the execution of WPPUS 148), thus freeing computer 100 from having to use its own computing resources.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

With reference then to FIG. 2, an overview of components used to create, partition and manage a master web page is presented. A content server 202 provides a content 204 to a web server 152. This content provides web server 152 with enough data to create a master web page 206, which is pulled by a browser 146. Within browser 146 is a web page partitioning logic 210, which partitions the master web page 206 into multiple partition caches 212a-i. Together, these multiple partition caches 212a-i form a partitioned web page 214, which is sent to a display 110. Partitioned web page 214 is made up of multiple partitions 216a-i. In a manner that is described in more detail below, updated content 218 for each of the partition caches 212 (and the corresponding partitions 216) is also pulled from content server 202 and transmitted to browser 146 via web server 152. Note that in one embodiment, the updated content 218 is sent directly from the content server 202 to the browser 146 after the browser receives an identifier for which partition cache 212 needs to be updated.

With reference now to FIG. 3, a flow-chart of exemplary steps taken to create and update a webpage is presented. Initiator block 302 may be prompted by any of multiple events, including a creation of a master web page 206 described above in FIG. 2. As described in block 304, such a master web page can be partitioned into multiple partitions, or, as described in FIG. 2, into multiple partition caches 212 as shown in FIG. 2, to create a partitioned web page. Each partition in the partition web page is correlated/matched with/to a partition cache (block 306) in the browser.

The browser then polls the web server for any invalidation events for any of the partitions/caches (block 308). In preferred embodiment, an invalidation event is defined as an event that causes content in a partition to change. For example, assume that the partitioned web page describes box scores for multiple ongoing baseball games, such that each partition in the partitioned web page is dedicated to a particular game. When a statistic for the game changes, such as a change in innings, a run is scored, a player is substituted, etc., this data needs to be reflected in the web page. However, it is a waste of bandwidth to create an entirely new web page, so only the affected partition is changed.

Thus, as shown in query block 310, if an invalidation event occurs, then the web server sends an identifier for the affected partition (“invalid partition”) to the browser (block 312). The browser then sends a request back to the web server asking for updated content for only the identified and affected partition (block 314). The web server retrieves the updated content from a content server (e.g., content server 202 shown in FIG. 2), and sends that updated content to the browser (block 316). In an alternate embodiment, the browser directly asks the content server for the updated content (using the identifier received from the web server), such that the updated content is more rapidly sent from the content server to the browser. The browser then updates only the affected partition (“invalid partition”) with the updated content (block 318), such that the partitioned web page is fully updated without having to change the other unaffected partitions. The process repeats in a reiterative manner (repeating the actions described in blocks 308-318) until ending at terminator block 320, at which point the web page is no longer updated.

Note that other invalidation events may exist for different types of web pages. For example, assume that the partitioned web page is for stock reports. When a particular stock price or sales volume changes, then in accordance with the procedure described above, the corresponding partition, in the partitioned web page, also changes, without changing the partitions for other stocks. Similarly, if the portioned web page is for sales figures for different divisions in an enterprise, each division will have a dedicated partition, such that changes for a particular division's sales will be reflected in the appropriate partition without affecting other partitions for other divisions. These examples are for representational illustration only, and are not to be construed as limiting the scope of the appended claims.

Note also that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for refreshing a web page, the method comprising:
partitioning a master web page into multiple partitions to create a partitioned web page;
correlating each of the multiple partitions to a corresponding partition cache in a browser;
polling a web server for an invalidation event, wherein the invalidation event changes a content of an invalid partition in the multiple partitions;
in response to the polling detecting the invalidation event, sending an identifier of the invalid partition to the browser;
utilizing the identifier to request updated content for the invalid partition;
sending the updated content to the browser; and
updating the invalid partition with the updated content to update the partitioned web page, wherein all other partitions of the partition web page remain unchanged.

2. The method of claim 1, wherein the polling and updating are performed by the browser.

3. The method of claim 1, wherein the polling and updating are performed by multiple browsers on different client machines.

4. The method of claim 1, wherein the master web page is provided by a web server, and wherein the updated content is provided directly to the corresponding partition cache by a different content server.

5. The method of claim 1, wherein the partitioned web page displays real-time scores of multiple games from a sport, and wherein the invalidation event is a change in a real-time score for a particular game that is associated with the invalid partition.

6. The method of claim 1, wherein the partitioned web page displays real-time stock prices for multiple stocks, and wherein the invalidation event is a change to a price for a particular stock that is associated with the invalid partition.

7. A system comprising:
a processor;
a data bus coupled to the processor;
a memory coupled to the data bus; and
a computer-usable medium embodying computer program code, the computer program code comprising instructions executable by the processor and configured for:
partitioning a master web page into multiple partitions to create a partitioned web page;
correlating each of the multiple partitions to a corresponding partition cache in a browser;
polling a web server for an invalidation event, wherein the invalidation event changes a content of an invalid partition in the multiple partitions;
in response to the polling detecting the invalidation event, sending an identifier of the invalid partition to the browser;
utilizing the identifier to request updated content for the invalid partition;
sending the updated content to the browser; and
updating the invalid partition with the updated content to update the partitioned web page, wherein all other partitions of the partition web page remain unchanged.

8. The system of claim 7, wherein the polling and updating are performed by the browser.

9. The system of claim 7, wherein the polling and updating are performed by multiple browsers on different client machines.

10. The system of claim 7, wherein the master web page is provided by a web server, and wherein the updated content is provided directly to the corresponding partition cache by a different content server.

11. The system of claim 7, wherein the partitioned web page displays real-time scores of multiple games from a sport, and wherein the invalidation event is a change in a real-time score for a particular game that is associated with the invalid partition.

12. The system of claim 7, wherein the partitioned web page displays real-time stock prices for multiple stocks, and wherein the invalidation event is a change to a price for a particular stock that is associated with the invalid partition.

13. A computer-readable medium encoded with a computer program, the computer program comprising computer executable instructions configured for:
partitioning a master web page into multiple partitions to create a partitioned web page;
correlating each of the multiple partitions to a corresponding partition cache in a browser;
polling a web server for an invalidation event, wherein the invalidation event changes a content of an invalid partition in the multiple partitions;
in response to the polling detecting the invalidation event, sending an identifier of the invalid partition to the browser;
utilizing the identifier to request updated content for the invalid partition;
sending the updated content to the browser; and
updating the invalid partition with the updated content to update the partitioned web page, wherein all other partitions of the partition web page remain unchanged.

14. The computer-readable medium of claim 13, wherein the polling and updating are performed by the browser.

15. The computer-readable medium of claim 13, wherein the polling and updating are performed by multiple browsers on different client machines.

16. The computer-readable medium of claim 13, wherein the master web page is provided by a web server, and wherein the updated content is provided directly to the corresponding partition cache by a different content server.

17. The computer-readable medium of claim 13, wherein the partitioned web page displays real-time scores of multiple games from a sport, and wherein the invalidation event is a change in a real-time score for a particular game that is associated with the invalid partition.

18. The computer-readable medium of claim 13, wherein the partitioned web page displays real-time stock prices for multiple stocks, and wherein the invalidation event is a change to a price for a particular stock that is associated with the invalid partition.

19. The computer-readable medium of claim 13, wherein the computer executable instructions are deployable to a client computer from a server at a remote location.

20. The computer-readable medium of claim 13, wherein the computer executable instructions are provided by a service provider to a customer on an on-demand basis.
